(19) United States
(12) Patent Application Publication
(10) Pub. No.: US 2024/0361248 A1
(43) Pub. Date: Oct. 31, 2024

(54) SYSTEM AND METHODS FOR SURFACE ENHANCED RAMAN SPECTROSCOPY

(71) Applicant: Beckman Coulter, Inc., Chaska, MN (US)

(72) Inventors: Takayuki MIZUTANI, Chaska, MN (US); Amit SAWHNEY, Chaska, MN (US); Kevin Louis NOWAK, Chaska, MN (US); Laura Elizabeth Schilling HOLMES, Chaska, MN (US); Jessica Melissa Mattke TUBMAN, Chaska, MN (US)

(21) Appl. No.: 18/661,672

(22) Filed: May 12, 2024

Related U.S. Application Data
(63) Continuation of application No. PCT/US2022/049153, filed on Nov. 7, 2022.
(60) Provisional application No. 63/278,577, filed on Nov. 12, 2021.

(51) Int. Cl. G01N 21/65; G01N 35/00; G01N 35/10

(52) U.S. Cl. CPC G01N 21/658; G01N 35/00693; G01N 35/0092; G01N 35/1002; G01N 2035/00346; G01N 2201/06113

(57) ABSTRACT

The presently claimed and described technology provides systems and methods for determining concentration of an analyte of interest using Surface Enhanced Raman Spectroscopy (SERS). An automated SERS system can include a body for accepting a substrate, a fluid handling system, a light source, and a detector that collects and detects Raman scattered light.

### RELATED APPLICATIONS

The present patent application claims the priority benefit of U.S. Provisional Patent Application Ser. No. 63/278,577, filed Nov. 12, 2021, the content of which is hereby incorporated by reference in its entirety into this disclosure.

### BACKGROUND

Clinicians and other physicians want to understand disease status by quickly and accurately identifying analytes, such as antigens & antibodies in biological fluids. There are quick detection methods, such as lateral flow detection, but the methods are limited by detection capability. For more accurate and precise diagnostic purposes, automated immunoassay systems are often used. However, these systems can be very complicated and expensive. Additionally, the development of immunoassay reagent kits requires many materials and long development times.

### BRIEF SUMMARY

p The inventors have leveraged Surface Enhanced Raman Spectroscopy (SERS) to quickly and accurately identify analytes. In one aspect, the disclosure provides an automated system configured to continuously accept and analyze sample fluids, wherein the automated system comprises:
a body, wherein the body has a rotational axis and at least one opening for receiving a substrate, wherein the substrate comprises at least one Surface Enhanced Raman Spectroscopy (SERS) reporter molecule;
a plurality of positions, wherein the plurality of positions comprises:
   at least one substrate loading position;
   at least one fluid dispensing position disposed after the at least one substrate loading position; and
   at least one detection position disposed after the at least one fluid dispensing position;
at least one heat source extending between the at least one substrate loading position and the at least one detection position;
a control system;
wherein the substrate is loaded onto the body when the body is at the at least one substrate loading position via a substrate transport device and the body is configured to move the substrate between the plurality of positions according to a schedule of the control system;
a fluid handling system configured to dispense a sample fluid comprising at least one analyte of interest;
at least one light source configured to excite the SERS reporter molecule;
a detector configured to collect and detect Raman scattered light from the at least one analyte of interest bound to the SERS reporter molecule and thereby produce a set of corresponding values when the substrate is at the at least one detection position; and
wherein the automated system is further configured to determine a presence and/or concentration of the at least one analyte of interest in the sample fluid using the corresponding values.

In some aspects of the system, a first portion of the at least one heat source extends between the at least one substrate loading position and the at least one fluid dispensing position. In some aspects, a second portion of the at least one heat source extends between the at least one fluid dispensing position and the at least one detection position.

In some aspects of the system, the control system Is scheduled to rotate the body sequentially from the at least one substrate loading position to the at least one fluid dispensing position to the at least one detection position.

In some aspects of the system, as the control system rotates the body from the at least one substrate loading position to the at least one fluid dispensing position, the first portion of the at least one heat source heats the substrate resulting in a pre-heated substrate.

In some aspects of the system, the fluid handling system dispenses the sample fluid onto the pre-heated substrate when the body is at the at least one fluid dispensing position.

In some aspects of the system, as the control system rotates the body from the at least one fluid dispensing position to the at least one detection position, the second portion of the at least one heat source heats the substrate resulting in a pre-heated substrate.

In some aspects of the system, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In another aspect of the system, the at least one fluid dispensing position comprises a first fluid dispensing position disposed after the at least one substrate loading position and a second fluid dispensing position disposed after the first fluid dispensing position. A first portion of the at least one heat source extends between the at least one substrate loading position and the second fluid dispensing position, and a second portion of the at least one heat source extends between the second fluid dispensing position and the at least one detection position.

In some aspects of the system, the control system is scheduled to rotate the body sequentially from the at least one substrate loading position to the second fluid dispensing position to the at least one detection position.

In some aspects of the system, as the control system rotates the body from the at least one substrate loading position to the second fluid dispensing position, the first portion of the at least one heat source heats the substrate resulting in a pre-heated substrate.

In some aspects of the system, the fluid handling system dispenses the sample fluid onto the pre-heated substrate when the body is at the second fluid dispensing position.

In some aspects of the system, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the system, as the control system rotates the body from the second fluid dispensing position to the at least one detection position, the second portion of the at least one heat source heats the substrate.

In some aspects of the system, the control system is scheduled to rotate the body sequentially from the at least one substrate loading position to the first fluid dispensing position to the second fluid dispensing position to the at least one detection position.

In some aspects of the system, as the body rotates from the at least one substrate loading position to the first fluid dispensing position, the first portion of the at least one heat source heats the substrate resulting in a pre-heated substrate.

In some aspects of the system, the fluid handling system dispenses one or more reagents and the sample fluid onto a pre-treatment portion of the substrate when the body is at the first fluid dispensing position to prepare a pre-treated sample fluid, wherein the pre-treatment portion of the substrate lacks the SERS reporter molecule.

In some aspects of the system, as the control system rotates the body from the first fluid dispensing position to the second fluid dispensing position, the first portion of the at least one heat source continues to heat the substrate.

In some aspects of the system, at least a portion of the substrate comprises the at least one SERS reporter molecule, and the fluid handling system aspirates the pre-treatment sample fluid and dispenses the pre-treatment sample fluid onto the portion of the substrate comprising the SERS reporter molecule when the body is at the second fluid dispensing position.

In some aspects of the system, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the system, as the control system rotates the body from the second fluid dispensing position to the at least one detection position, the second portion of the at least one heat source heats the substrate.

In some aspects of the system, the plurality of positions further comprises a substrate unloading position. After detection, the control system is scheduled to rotate the body from the at least one detection position to the substrate unloading position.

In some aspects of the system, the fluid handling system comprises a container handler and/or a pipettor arrangement.

In some aspects of the system, determining one analyte constitutes a test performed by the automated system, and the automated system is configured to perform about at least 10 tests per hour, alternatively about at least 100 tests per hour, alternatively about at least 400 tests per hour.

In some aspects of the system, the sample fluid is a biological or chemical sample such as whole blood, plasma, serum, saliva, urine, cerebrospinal fluid, lacrimal fluid, perspiration, gastrointestinal fluid, amniotic fluid, mucosal fluid, pleural fluid, or sebaceous oil. The biological sample can be collected from a mammalian subject.

In some aspects of the system, the substrate comprises a first SERS reporter molecule bound to a first analyte capture agent and a second SERS reporter molecule bound to a second analyte capture agent.

In some aspects of the system, the substrate is a solid substrate. In some aspects, the substrate is substantially planar.

In some aspects of the system, the substrate includes at least one position for receiving the sample fluid and at least one position for receiving a calibrator. In some aspects, the substrate comprises at least two positions for a calibrator, alternatively at least three positions for a calibrator, alternatively at least four positions for a calibrator.

In some aspects of the system, the substrate is a microstructure chip or a microfluidic chip.

In some aspects of the system, the substrate is removably coupled to a microneedle patch, the microneedle patch comprising a microneedle array, a patch adhesive, the substrate, and a collection cavity. The patch adhesive can be, for example, a bandage or a topical dressing.

In some aspects of the system, the substrate extends from and is removably coupled to a container cap, the container cap being removably coupled to a container, wherein the container contains the sample fluid, and the sample fluid is drawn into the substrate via capillary action. The container can be, for example, a test tube, a vial, or a cuvette. In some aspect, the substrate is transferred from the container cap onto the body using the substrate transport device.

In some aspects of the system, the calibrator is deposited onto the substrate prior to loading onto the body.

In some aspects of the system, the substrate is a liquid suspension of nanoparticles, wherein a plurality of SERS reporter molecules are attached to each nanoparticle.

In some aspects of the system, the sample fluid is deposited onto the substrate prior to the substrate being loaded onto the body. When a sample fluid is deposited onto the substrate prior to the substrate being loaded onto the body, the control system is scheduled to rotate the body sequentially from the at least one substrate loading position to the at least one detection position, alternatively from the at least one substrate loading position to the first fluid dispensing position to the at least one detection position.

In some aspects of the system, the fluid handling system dispenses the calibrator and the sample fluid onto the substrate.

In some aspects of the system, the substrate transport device continuously loads at least one substrate onto the body.

In some aspects of the system, the control system uses the corresponding values from the detector to determine the presence and/or concentration of the at least one analyte in the sample fluid.

In some aspects, the at least one light source moves in the x-axis of the rotational axis of the body.

In some aspects, the at least one light source comprises a laser that emits a single wavelength of electromagnetic radiation in the 700-800 nm range.

In another aspect, the disclosure provides a method of continuously accepting and analyzing a plurality of sample fluids, the method comprising:
continuously providing an automated system with a plurality of sample fluids, wherein the automated system comprises:
   a body, wherein the body has a rotational axis and at least one opening for receiving a substrate, wherein the substrate comprises at least one Surface Enhanced Raman Spectroscopy (SERS) reporter molecule;
   a plurality of positions, wherein the plurality of positions comprises:
      at least one substrate loading position;
      at least one fluid dispensing position disposed after the at least one substrate loading position; and
      at least one detection position disposed after the at least one fluid dispensing position;
   at least one heat source extending between the at least one substrate loading position and the at least one detection position;
   a control system;
   a substrate transport device;
   a fluid handling system configured to dispense a sample fluid comprising at least one analyte of interest;
   at least one light source configured to excite the SERS reporter molecule;
   a detector configured to collect and detect Raman scattered light from the at least one analyte of interest bound to the SERS reporter molecule; and
wherein continuously providing an automated system with the plurality of sample fluids comprises:
loading the substrate onto the body when the body is at the at least one substrate loading position via the substrate transport device;
dispensing the sample fluid from the fluid handling system onto the substrate; scheduling the control system to rotate the body between the plurality of positions; exciting the SERS reporter molecule with the at least one light source;
collecting the detecting Raman scattered light from the at least one analyte of interest bound to the SERS reporter molecule to produce a set of corresponding values; and
determining a presence and/or concentration of the at least one analyte in the at least one sample fluid using the corresponding values.

In some aspects of the method, a first portion of the at least one heat source extends between the at least one substrate loading position and the at least one fluid dispensing position, and a second portion of the at least one heat source extends between the at least one fluid dispensing position and the at least one detection position.

In some aspects of the method, scheduling the control system to rotate the body between the plurality of positions comprises rotating the body sequentially from the at least one substrate loading position to the at least one fluid dispensing position to the at least one detection position.

In some aspects of the method, the method further comprises heating the substrate with the first portion of the at least one heat source as the body rotates from the at least one substrate loading position to the at least one fluid dispensing position.

In some aspects of the method, the method further comprises dispensing the sample fluid onto the substrate when the body is at the at least one fluid dispensing position.

In some aspects of the method, the method further comprises heating the substrate with the second portion of the at least one heat source as the body rotates from the at least one fluid dispensing position to the at least one detection position.

In some aspects of the method, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the method, the at least one fluid dispensing position comprises a first fluid dispensing position disposed after the at least one substrate loading position and a second fluid dispensing position disposed after the first fluid dispensing position.

In some aspects of the method, a first portion of the at least one heat source extends between the at least one substrate loading position and the second fluid dispensing position and a second portion of the at least one heat source extends between the second fluid dispensing position and the at least one detection position.

In some aspects of the method, scheduling the control system to rotate the body between the plurality of positions comprises rotating the body sequentially from the at least one substrate loading position to the second fluid dispensing position to the at least one detection position. In some aspects of the method, the method further comprises heating the substrate with the first portion of the at least one heat source as the body rotates from the at least one substrate loading position to the second fluid dispensing position.

In some aspects of the method, the method further comprises dispensing the sample fluid onto the substrate when the body is at the second fluid dispensing position.

In some aspects of the method, the method further comprises heating the substrate with the second portion of the at least one heat source as the body rotates from the second fluid dispensing position to the at least one detection position.

In some aspects of the method, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the method, scheduling the control system to rotate the body between the plurality of positions comprises rotating the body sequentially from the at least one substrate loading position to the first fluid dispensing position to the second fluid dispensing position to the at least one detection position.

In some aspects of the method, the method further comprises heating the substrate with the first portion of the at least one heat source as the body rotates from the at least one substrate loading position to the first fluid dispensing position.

In some aspects of the method, the method further comprises dispensing one or more reagents and the sample fluid onto a pre-treatment portion of the substrate when the body is at the first fluid dispensing position, wherein the pre-treatment portion of the substrate lacks the SERS reporter molecule.

In some aspects of the method, the method further comprises heating the substrate with the first portion of the at least one heat source as the body rotates from the first fluid dispensing position to the second fluid dispensing position.

In some aspects of the method, the method further comprises aspirating the sample fluid from the pre-treatment portion of the substrate and dispensing the sample fluid onto a portion of the substrate comprising the at least one SERS reporter molecule when the body is at the second fluid dispensing position.

In some aspects of the method, the method further comprises heating the substrate with the second portion of the at least one heat source as the body rotates from the second fluid dispensing position to the at least one detection position.

In some aspects of the method, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the method, the plurality of positions of the automated system further comprises a substrate unloading position, and the method further comprises rotating the body from the at least one detection position to the substrate unloading position.

In some aspects of the method, the fluid handling system comprises a container handler and/or pipettor arrangement.

In some aspects of the method, the method further comprises moving the at least one light source in the x-axis of the rotational axis of the body.

In some aspects of the method, determining one analyte constitutes a test performed by the automated system, and the method further comprises performing about at least 10 tests per hour, alternatively at least 100 tests per hour, alternatively at least 400 tests per hour.

In some aspects, the method further comprises calibrating the automated system via a calibrator deposited on the substrate. In some aspects, the calibrator is dispensed by the fluid handling system.

In some aspects of the method, the substrate is a solid substrate. In some aspects, the substrate is a microstructure chip or a microfluidic chip. In some aspects, the substrate is removably coupled to a microneedle patch, wherein the microneedle patch comprises a microneedle array, a patch adhesive, the substrate, and a collection cavity. The patch adhesive can be a bandage or topical dressing.

In some aspects of the method, the substrate extends from and is removably coupled to a container cap, the container cap being removably coupled to a container, wherein the container contains the sample fluid, and the sample fluid is drawn into the substrate via capillary action. The container can be a test tube, vial, or cuvette.

In some aspects of the method, the automated system further comprises a substrate handler configured to remove the cap from the container and the method further comprising removing the cap from the container to expose the substrate.

In some aspects of the method, the substrate is a liquid suspension of nanoparticles, wherein a plurality of SERS reporter molecules are attached to each nanoparticle.

In some aspects of the method, the method further comprises depositing the fluid sample onto the substrate prior to the substrate being loaded onto the body. In some aspects, the method further comprises rotating the body sequentially from the at least one substrate loading position to the at least one detection position, alternatively from the at least one substrate loading position to the first fluid dispensing position to the at least one detection position. In some aspects of the method, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects, the at least one light source comprises a laser that emits a single wavelength of electromagnetic radiation in the 700-800 nm range from the laser.

In a further aspect, the disclosure provides a method of continuously accepting and analyzing a plurality of sample fluids, the method comprising:
depositing a sample fluid comprising at least one analyte of interest onto a substrate, wherein at least a portion of the substrate is coated with at least one Surface Enhanced Raman Spectroscopy (SERS) reporter molecule;
continuously providing an automated system with a plurality of substrates, wherein the automated system comprises:
   a body having a rotational axis, at least one substrate loading position comprising an opening for receiving the substrate and at least one detection position;
   a control system;
   a substrate transport device;
   at least one light source configured to excite the SERS reporter molecule;
   a detector configured to collect and detect Raman scattered light from the sample fluid bound to the substrate; and
wherein continuously providing an automated system with the plurality of sample fluids comprises:
loading the substrate onto the body via the substrate transport device;
scheduling the control system to rotate the body from the at least one substrate loading position to the at least one detection position;
exciting the SERS reporter molecule with the at least one light source;
collecting and detecting Raman scattered light from the at least one analyte of interest bound to the SERS reporter molecule to produce a set of corresponding values; and
determining a presence and/or concentration of the at least one analyte of interest in the sample fluid using the corresponding values.

In some aspects of the method, the substrate extends from and is removably coupled to a container cap, the container cap being removably coupled to a container, wherein the container contains the sample fluid, and the sample fluid is drawn into the substrate via capillary action. The container can be a test tube, a vial, or a cuvette.

In some aspects, the automated system further comprises a substrate handler configured to remove the cap from the container, and the method further comprises removing the container cap from the container to expose the substrate extending from the container cap after the substrate is loaded onto the body.

In some aspects, the body further comprises a substrate unloading position and the method further comprising rotating the body from the at least one detection position to the at least one substrate unloading position to unload the substrate.

In some aspects of the method, the SERS reporter molecule is bound to an analyte capture agent that binds the analyte of interest. In some aspects, the analyte capture agent is an antibody or a fragment thereof. In some aspects, the analyte capture agent is an antigen and the analyte of interest is an antibody.

In some aspects of the method, the method further comprises moving the at least one light source in the x-axis of the rotational axis of the body.

In some aspects of the method, determining one analyte constitutes a test performed by the automated system, and the method further comprises performing about at least 10 tests per hour, alternatively at least 100 tests per hour, alternatively at least 400 tests per hour.

In some aspects of the method, the method further comprises calibrating the automated system via a calibrator deposited on the substrate.

These and other advantages, aspects, and novel features of the present disclosure, as well as details of an illustrated embodiment thereof, will be more fully understood from the following description and drawings.

### BRIEF DESCRIPTION OF THE DRAWINGS

Various aspects of the present disclosure will now be described, by way of example only, with reference to the attached Figures, wherein:

FIG. 1 illustrates a block diagram of an automated Surface Enhanced Raman Spectroscopy (SERS) system.

FIG. 2A illustrates a block diagram of the body of an automated SERS system according to an aspect of the disclosure.

FIG. 2B illustrates a block diagram of the body of an automated SERS system according to another aspect of the disclosure.

FIG. 2C illustrates a block diagram of the body of an automated SERS system according to a further aspect of the disclosure.

FIG. 2D illustrates a block diagram of the body of an automated SERS system according to a further aspect of the disclosure.

FIG. 3 illustrates a block diagram of the fluid handling system of an automated SERS system according to an aspect of the disclosure.

FIG. 4A illustrates a substrate for an automated SERS system according to some aspects of the disclosure.

FIG. 4B illustrates another substrate for an automated SERS system according to some aspects of the disclosure.

FIG. 4C illustrates yet another substrate for an automated SERS system according to some aspects of the disclosure.

FIG. 4D illustrates a further substrate for an automated SERS system according to some aspects of the disclosure.

FIG. 4E illustrates another substrate for an automated SERS system according to some aspects of the disclosure.

FIG. SA illustrates a substrate comprising nanoparticles coated with a SERS reporter molecule.

FIG. SB illustrates the substrate of SB with an analyte capture agent bound to the SERS reporter molecule.

FIG. SC illustrates the substrate of SB binding an analyte in a sample fluid.

FIG. 6 illustrates a microneedle patch assembly comprising a substrate according to some aspects of the disclosure.

FIG. 7A illustrates a container-cap assembly comprising a substrate according to some aspects of the disclosure.

FIG. 7B illustrates a block diagram of the body of an automated SERS system according to an aspect of the disclosure.

FIG. 7C illustrates a block diagram of the body of an automated SERS system according to an aspect of the disclosure.

FIG. 8A is a flow chart diagram illustrating an automated SERS method according to some aspects of the disclosure.

FIG. 8B is a flow chart diagram illustrating another automated SERS method according to some aspects of the disclosure.

FIG. 8C is a flow chart diagram illustrating another automated SERS method according to some aspects of the disclosure.

FIG. 9 is a flow chart diagram illustrating an automated SERS method using a pre-filled substrate according to some aspects of the disclosure.

FIG. 10 illustrates a block diagram of the body of an automated SERS system according to an aspect of the disclosure.

FIG. 11A is a plot of signal intensity as a function of shift of a Raman peak or feature when a SERS reporter molecule-analyte capture agent complex binds an analyte of interest.

FIG. 11B is a plot of spectra data obtained in Example 2.

FIG. 11C is a plot of the Raman peak position in cm·¹ as a function of log10 of the TSH concentration corresponding to the Raman shift data of FIG. 11B.

### DETAILED DESCRIPTION

Unless otherwise defined, all technical and scientific terms used herein have the same meaning as commonly understood by one of ordinary skill in the art to which the methods described herein belong. The singular form “a”, “an” and “the” include plural referents unless the context clearly dictates otherwise. These articles refer to one or to more than one (i.e., to at least one).

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

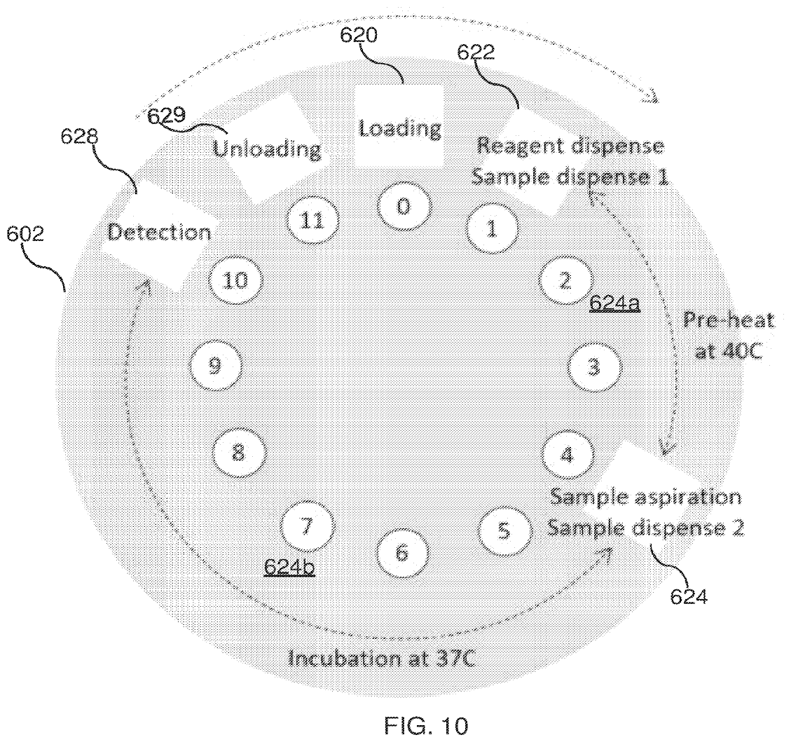

The present disclosure relates to systems and methods for performing automated Surface Enhanced Raman Spectroscopy. Surface Enhanced Raman Spectroscopy (SERS) is a vibrational spectroscopy technique that enhances or amplifies Raman signals of molecules absorbed onto (or close to) surfaces, such as gold or silver. This amplification allows for label-free detection of low concentrations of analytes. “Raman signal”, “Raman scattering”, and “Raman effect” as used herein refer to the inelastic scattering of photons by matter (e.g., analytes). Exemplary SERS methods are shown in FIGS. 5A-5C and FIGS. 10A-10C.

As used herein, “automated” or “automatic” Surface Enhanced Raman Spectroscopy will be understood to mean Surface Enhanced Raman Spectroscopy performed entirely on an instrument with no offline steps performed manually by an operator. More specifically, the disclosure describes systems and methods for continuously accepting and analyzing sample fluids by Surface Enhanced Raman Spectroscopy. In some aspects, continuously accepting and analyzing sample fluids is achieved by an automated system equipped with a queue of single-use substrates comprising one or more Surface Enhanced Raman Spectroscopy reporter molecules. The automated system loads a substrate in the queue, dispenses a sample fluid comprising an analyte of interest onto the substrate, performs Surface Enhanced Raman Spectroscopy, unloads the used or exhausted substrate, loads the next substrate in the queue, and dispenses another sample fluid.

Disclosed herein is an automated system comprising a body for accepting a substrate, a fluid handling system, a light source, and a detector that collects and detects Raman scattered light. In some aspects, the fluid handling system can be separate from the body, light source, and detector. In some aspects, the fluid handling system can be fully or partially integrated with the body, light source, and detector. In exemplary aspects, the body, fluid handling system, light source, and detector are individual components of a modular laboratory automation system having a workflow that continuously accepts and analyzes sample fluids via Surface Enhanced Raman Spectroscopy (SERS). In some aspects, the modular laboratory automation system can include the automated system as disclosed herein (i.e., the automated system for SERS) and one or more additional analyzers or analyzing components such as mass spectrometers, immunoassay analyzers, hematology analyzers, microbiology analyzers, and/or molecular biology analyzers.

The term “analyze” as used herein refers to the capability of determining the presence of an analyte, measuring the concentration of an analyte, and/or otherwise characterizing properties of an analyte in a biological or chemical sample fluid. As used herein, “analyte” refers to a substance whose presence, absence, or concentration is determined using the systems and methods described herein. Analytes can include, but are not limited to, organic molecules, hormones (such as thyroid hormones, estradiol, testosterone, progesterone, estrogen), metabolites (such as glucose or ethanol), proteins (such as antibodies or antigens), lipids, carbohydrates and sugars, steroids (such as Vitamin D), peptides (such as procalcitonin), nucleic acid segments, biomarkers, pharmaceuticals (such as antibiotics, benzodiazepine), drugs (such as immunosuppressant drugs, narcotics, opioids, etc.), molecules with a regulatory effect m enzymatic processes such as promoters, activators, inhibitors, or cofactors, microorganisms (such as viruses (including EBV, HPV, HIV, HCV, HBV, Influenza, Norovirus, Rotavirus, Adenovirus, etc.), bacteria (H. pylori, Streptococcus, MRSA, C. cliff, Ligionella, etc.), fungus, parasites (plasmodium, etc.), cells, cell components (such as cell membranes), spores, nucleic acids (such as DNA and RNA), etc. In some aspects, the automated system allows for simultaneous analysis of multiple analytes in the same class or different classes (e.g., simultaneous analysis of metabolites and proteins).

Sample fluids of the present disclosure include, but are not limited to, biological and chemical samples. Biological samples such as biological fluids collected from a subject include blood, plasma, serum, saliva, urine, cerebrospinal fluid, lacrimal fluid, perspiration, gastrointestinal fluid, amniotic fluid, mucosal fluid, pleural fluid, sebaceous oil, and exhaled breath. Chemical samples can include any suitable type of sample having a chemical constituent, including water samples. The automated SERS system can be used to measure or determine the presence of a variety of analytes from these sample fluids.

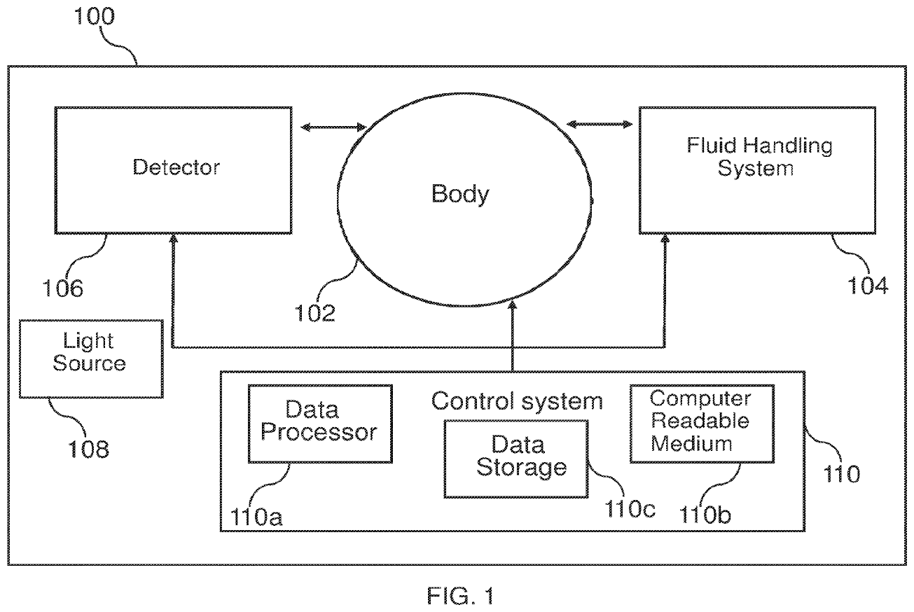

FIG. 1 illustrates a high-level block diagram of an automated SERS system according to an aspect of the disclosure. An automated SERS system 100 comprises body 102, fluid handling system 104, detector 106, and light source 108. In some aspects, fluid handling system 104 can be integrated with a sample processing system, such as those described in PCT Application No. WO2018/217778, published Nov. 29, 2018, which is incorporated herein by reference in its entirety. Fluid handling system 104 can be physically and/or operationally coupled to body 102, detector 106, and light source 108. In some aspects, fluid handling system 104, body 102, detector 106, and light source 108 can form a single instrument.

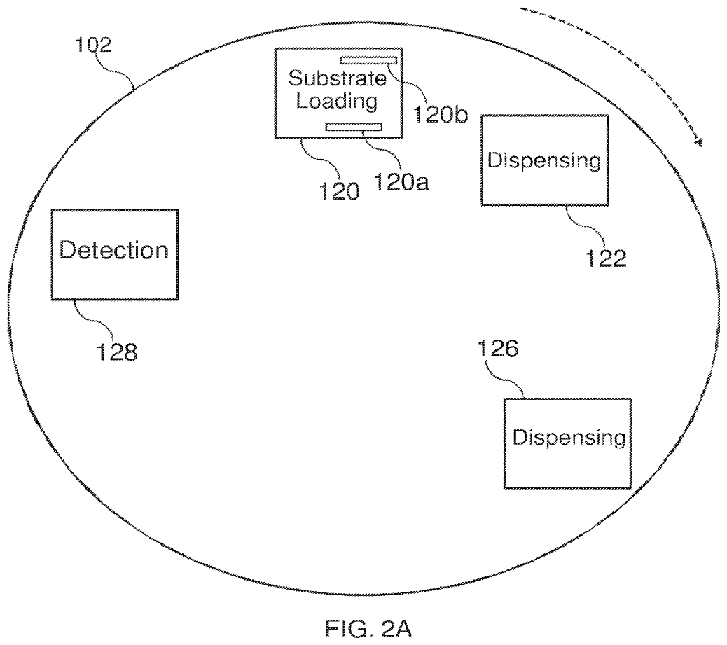

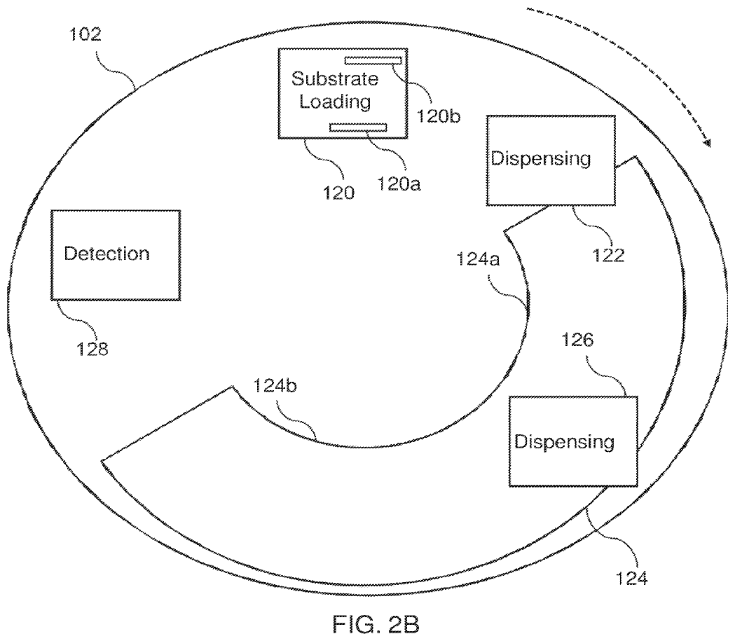

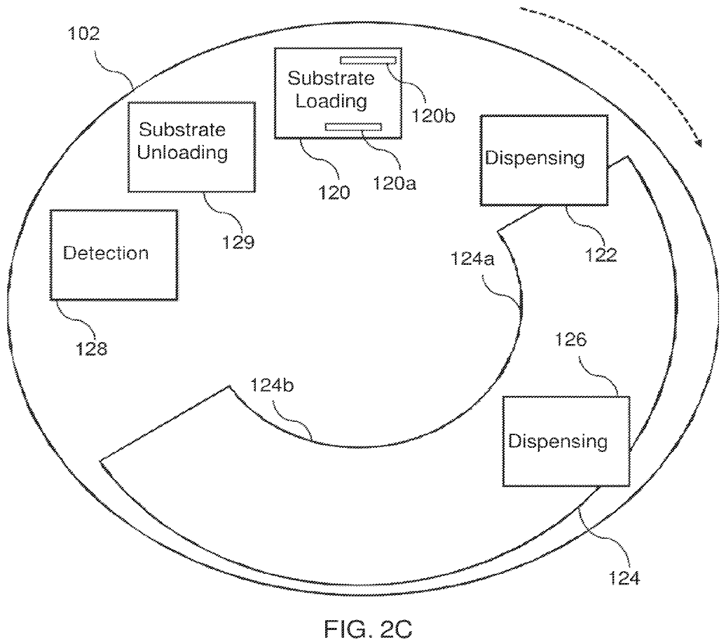

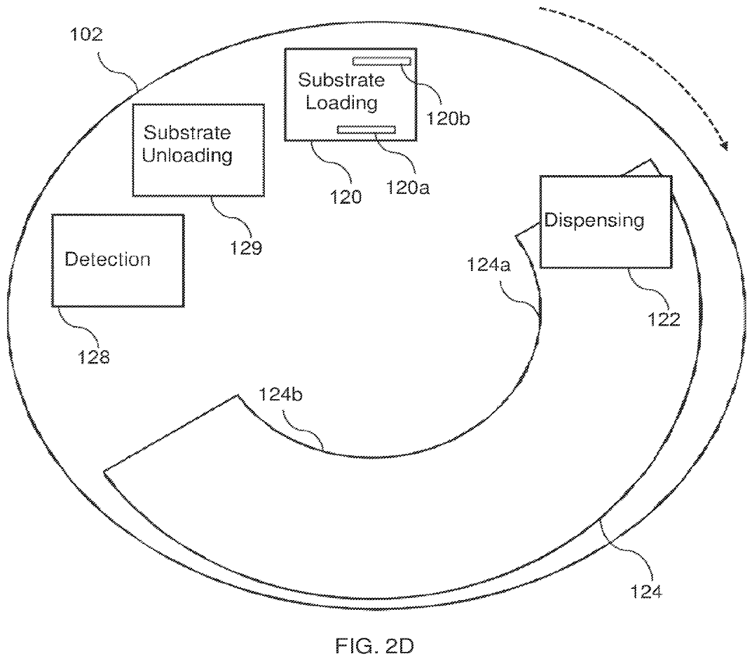

Body 102 of automated SERS system 100 has a rotational axis and is disposed within the system such that once body 102 accepts a substrate, it rotates the substrate about the body axis to a plurality of positions, each position for performing a method step for SERS analysis or a functional step for the operation of system 100 (e.g., loading & unloading substrates). FIG. 2A illustrates an embodiment of body 102 having position 120, position 122, and position 128. Position 120 is a substrate loading position (“substrate loading position 120”) in which a substrate is inserted, dispensed, or otherwise loaded onto body 120 by a substrate transport device. At substrate loading position 120, body 102 can include opening 120a disposed therein for accepting a substrate from substrate transport device 120b. Opening 120a can be, for example, a slot having a circular, square, or rectangular geometry. In some aspects, opening 120a can accept a solid substrate, a liquid substrate, or both. In some aspects, body 102 can include a first opening for accepting a solid substrate and a second opening for accepting a liquid substrate. In some aspects, loading position 120 can include a plurality of openings, alternatively four openings, alternatively five openings, alternatively ten openings, alternatively 20 openings, alternatively 50 openings, alternatively 100 openings, alternatively 150 openings, alternatively 150 openings, alternatively 200 openings, alternatively 250 openings, alternatively 300 openings, alternatively 350 openings, for accepting multiple substrates.

Position 122 is a first fluid dispensing position (“fluid dispensing position 122”). At first fluid dispensing position 122, fluid handling system 104 can dispense or provide one or more reagents and/or a sample fluid to the substrate.

In some aspects, first fluid dispensing position 122 can include various apparatuses for processing or preparing a sample such as, but not limited to, diluent and/or reagent addition stations (e.g., diluent pipetting stations and/or reagent pipetting stations), diluent storage units, reagent storage units, etc.

In exemplary aspects, at first fluid dispensing position 122, a sample fluid is treated with one or more denaturing agents dispensed by fluid handling system 104. This is particularly applicable when the analyte of interest in the sample fluid is a protein. Suitable denaturing agents are known to one of ordinary skill.

In some aspects, a sample fluid can be diluted at first fluid dispensing position 122. The need for sample dilution would be known to one of ordinary skill and based on identity of the sample fluid. In some aspects, a sample fluid can be diluted in a range between 10×-10,000×.

Body 102 can further comprise a second fluid dispensing position 126. At second fluid dispensing position 126, fluid handling system 104 can dispense or provide a sample fluid to the substrate

In some aspects, second fluid dispensing position 126 can include various apparatuses for processing or preparing a sample such as, but not limited to, diluent and/or reagent addition stations (e.g., diluent pipetting stations and/or reagent pipetting stations), diluent storage units, reagent storage units, etc.

In some aspects, a sample fluid can be diluted at second fluid dispensing position 126.

It will be understood that sample fluid manipulation (e.g., sample dilution, reagent addition, sample denaturing) can occur at first fluid dispensing position 122, second fluid dispensing position 126, or both, depending on the schedule of control system 110.

Position 128 is a detection position (“detection position 128”). At detection position 128, light source 108 excites a SERS reporter molecule disposed on the substrate and detector 106 collects and detects Raman scattered light from a sample fluid bound to the substrate.

It will be understood that the automated SERS system disclosed herein can have more than one substrate loading position, first and second fluid dispensing positions, and/or detection position. For example, in some aspects, an automated SERS system can have two substrate loading, first and second fluid dispensing, and/or detection positions, alternatively three substrate loading, first and second fluid dispensing, and/or detection positions, alternatively four substrate loading, first and second fluid dispensing, and/or detection positions, alternatively five substrate loading, first and second fluid dispensing, and/or detection positions, alternatively six substrate loading, first and second fluid dispensing, and/or detection positions, alternatively seven substrate loading, first and second fluid dispensing, and/or detection positions, alternatively eight substrate loading, first and second fluid dispensing, and/or detection positions, alternatively nine substrate loading, first and second fluid dispensing, and/or detection positions, alternatively ten substrate loading, first and second fluid dispensing, and/or detection positions.

In some aspects, such as those illustrated in FIG. 2B, body 102 can further comprise heat source 124 that extends between the substrate loading position and the detection position of automated SERS system 100. In exemplary aspects, heat source 124 has first portion 124a disposed between substrate loading position 120 and second fluid dispensing position 126 such that substrate and/or sample heating overlaps with first fluid dispensing position 122. It will be understood that first heat position 124a and second heat position 124b can be continuous (i.e., connected) or discontinuous (i.e., separate heat sources). Heat source 124 can be any suitable heat source known to one of ordinary skill such as a lamp, laser, or incubator. In exemplary aspects, heat source 124 comprises a heat sheet extending between substrate loading position 120 and detection position 128, the heat sheet being coupled to an incubator.

Heat source 124 can maintain body 102 at 37° C. at both first and second portions 124a and 124b. In some aspects, first portion 124a of heat source 124 pre-heats a substrate at about 40° C. while second portion 124b is maintained at 37° C.

At position 128 (“detection position 128”), light source 108 excites a SERS reporter molecule disposed on the substrate, and detector 106 (i.e., a Raman spectrometer or another device capable of performing Raman spectroscopy) collects and detects Raman scattered light from a sample fluid bound to the substrate to produce a set of corresponding values, which are subsequently used to determine the presence and/or concentration of one or more analytes in the sample fluid. As used herein, “corresponding values” will be understood to mean a Raman peak shift that is specific to and representative of an analyte of interest.

In some aspects, light source 108 moves in the x-axis of the rotational axis of body 102.

In some aspects, light source 108 is a laser, such as an infrared laser, visible spectrum laser, ultraviolet (UV) laser, continuous-wave laser, pulsed laser, ultra-short pulsed laser, solid-state, or gas laser. The laser can emit a single wavelength of electromagnetic radiation. In some aspects, the laser emits two wavelengths of electromagnetic radiation, alternatively three wavelengths of electromagnetic radiation, alternatively four wavelengths of electromagnetic radiation. In some aspects, light source 108 is a source of monochromatic light such as from a laser in the visible (400 nm-750 nm) or near infrared (750 nm-2.5 μm) range. In some aspects, light source 108 emits light in the 700 nm-800 nm range, alternatively in the 750 nm-800 nm range, alternatively in the 775 nm-800 nm range, alternatively in the 780 nm-800 nm range. In exemplary embodiments, light source 108 emits light at 785 nm.

In some aspects, light source 108 is a laser that emits light in the 700 nm-800 nm range, alternatively in the 750 nm-800 nm range, alternatively in the 775 nm-800 nm range, alternatively in the 780 nm-800 nm range. In exemplary embodiments, light source 108 is a laser that emits light at 785 nm.

In some aspects, used or exhausted substrates can be unloaded from body 102 via substrate loading position 120. Alternatively, as shown in FIG. 2C, body 102 can further comprise substrate unloading position 129. At substrate unloading position 129, used solid substrates can be unloaded from body 102 via substrate transport device 120b or another transport device. In some aspects, at substrate unloading position 129, used liquid substrates can be aspirated and discarded into a waste container disposed within automated SERS system 100. Alternatively, expended liquid substrates can be aspirated and discarded outside of automated SERS system 100 via a fluid line that carries liquid substrate/sample fluid to an external waste container. It will be understood that substrate unloading position 129 can unload or dispose of both solid and liquid substrates.

It will be understood that the system is not required to have two fluid dispensing positions. For example, as shown in FIG. 2D, body 102 can comprise substrate loading position 120, fluid dispensing position 122, detection position 128, substrate unloading position 129, and heat source 124. In this aspect, at fluid dispensing position 122, fluid handling system 104 dispenses a sample fluid and optionally one or more calibrators, positive and negative controls, diluents, detergents, denaturing agents, blocking agents, and/or other agents known to one of ordinary skill for immunodetection and SERS analysis.

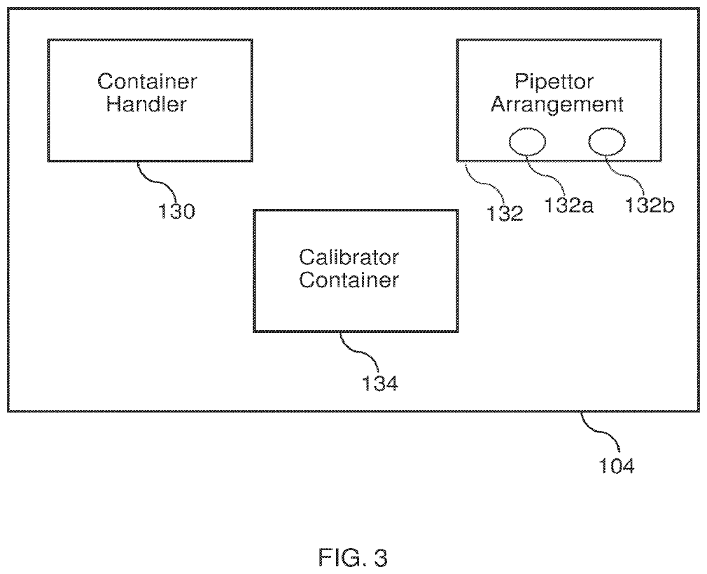

Turning to FIG. 3, fluid handling system 104 is shown. Fluid handling system 104 can include sample container handler 130 and/or pipettor arrangement 132. It will be understood that the fluid handling system can have either or both sample container handler 130 and pipettor arrangement 132. Sample container handler 130 can be any suitable apparatus used to handle or transport a sample container. Exemplary container handlers include, but are not limited to, pick-and-place devices, such as pick-and-place transfer gantrys, transfer shuttles, such as extended linear reaction shuttles, or combinations of pick-and-place transfer gantrys and extended linear reaction shuttles. In some aspects, sample container handler 130 comprises at least one pick-and-place gripper. A detailed description of the configurations and functions of pick-and-place grippers is provided in U.S. Pat. No. 7,128,874, which is herein incorporated by reference in its entirety.

Fluid handling system 104 can optionally include calibrator container 103 such as a cuvette, a tube, a vial, wells in a pack, etc. In some aspects, fluid handling system 104 can comprise multiple calibrator containers, such as two containers, three containers, or four or more containers.

Pipettor arrangement 132 includes at least one pipettor 132a that can dispense a sample fluid onto a substrate when body 102 is at sample fluid dispensing position 122. Pipettor arrangement 132 can optionally include a second pipettor 132b that can dispense a sample fluid and/or calibrator onto the substrate. Each pipettor can include an ultrasonic transducer and a probe. The ultrasonic transducer applies ultrasonic vibrations to the probe's tip to deliver sample or calibrator, clean the probe after each use, and sense the level of fluid in a calibrator or sample container. Each pipettor can also include a fluid pump and associated valve to aspirate samples or calibrators into the probe. The fluid pump can be driven by an actuator, such as a motor. In some aspects, the motor is a stepper motor that permits precise adjustment of the volume of fluid dispensed by the pipettor.

In some aspects, fluid handling system 104 can further dispense calibrators, positive and negative controls, and/or additional reagents (e.g., antibodies for binding an analyte of interest) onto a substrate.

In some aspects, fluid handling system 104 can further dispense diluents, detergents, denaturing agents, blocking agents, and other agents known to one of ordinary skill for immunodetection and SERS analysis.

In some aspects, calibrators and/or controls can be deposited onto a substrate prior to loading onto body 102.

In some aspects, the automated SERS system 100 can further comprise a control system 110 (FIG. 1). In the context of this disclosure, “controller” and “control system” are used interchangeably and refer to the same component or subset of components. Control system 110 can control, operate, and manipulate the body 102, the fluid handling system 104, the detector 106, and/or the light source 108. In some aspects, the control system 110 can comprise a data processor 110a, a non-transitory computer-readable medium 110b, and a data storage 110c, wherein the non-transitory computer-readable medium 110b and the data storage 110c are operatively coupled to the data processor 110a. The non-transitory computer-readable medium 110b includes code, executable by the data processor 110a, which performs the functions described herein. The data storage 110c stores data for processing samples, sample data, and/or data for analyzing sample data.

The data processor 110 can include any suitable data computation device or combination of such devices. An exemplary data processor can comprise one or more microprocessors working together to accomplish a desired function. The data processor 110a can include a CPU having at least one high-speed data processor adequate to execute program components for executing user and/or system-generated requests. The CPU can be a microprocessor such as AMD's Athlon, Duron and/or Opteron, IBM and/or Motorola's PowerPC, IBM's and Sony's Cell processor, Apple's MI, Intel's Celeron, Itanium, Pentium, Xeon, and/or XScale; and/or the like processor(s).

The computer-readable medium 110b and the data storage 110c can be any suitable device or devices that can store electronic data. Examples of memories include one or more memory chips, disk drives, etc. that operate using any suitable electrical, optical, and/or magnetic mode of operation.

The computer-readable medium 110b can comprise code, executable by the data processor 110a to perform any suitable method. For example, the computer-readable medium 110b can comprise code, executable by the processor 110a, to perform functions, such as but not limited to:
a. calibrate detector 106 for detection of one or more analytes;
b. rotate a substrate via body 102 sequentially to the plurality of positions 120-128;
c. dispensing volumes of sample fluid, calibrators, controls, and or reagents (e.g., diluents, detergents, denaturing agents, blocking agents, antibodies) via fluid handling system 104;
d. actuate the substrate transport device to load/unload substrates; and
e. utilize corresponding values from the detector to determine the presence and/or concentration of one or more analytes in a sample fluid

Control system 110 is configured to rotate body 102 through the plurality of positions to perform SERS analysis. In some aspects, control system 110 sequentially rotates body 102 as follows:
a. to substrate loading position 120 to accept a substrate;
b. to second fluid dispensing position 126 to dispense a sample fluid and optionally one or more calibrators, positive and negative controls, diluents, detergents, denaturing agents, blocking agents, and/or other agents known to one of ordinary skill for immunodetection and SERS analysis reagent via fluid handling system 104; and
c. to detection position 128 for SERS analysis, wherein heat source 124 heats the substrate as body 102 rotates from substrate loading position 120 to detection position 128.

In some aspects, control system 110 sequentially rotates body 102 as follows:
a. to substrate loading position 120 to accept a substrate;
b. to first fluid dispensing position 122 to dispense a sample fluid and optionally one or more calibrators, positive and negative controls, diluents, detergents, denaturing agents, blocking agents, and/or other agents known to one of ordinary skill for immunodetection and SERS analysis reagent via fluid handling system 104;
c. to second fluid dispensing position 124 and optionally one or more calibrators, positive and negative controls, diluents, detergents, denaturing agents, blocking agents, and/or other agents known to one of ordinary skill for immunodetection and SERS analysis reagent via fluid handling system 104; and
d. to detection position 128 for SERS analysis, wherein heat source 124 heats the substrate as body 102 rotates from substrate loading position 120 to detection position 128.

In some aspects, when body 102 comprises a singular fluid dispensing position, control system 110 sequentially rotates body 102 as follows:
a. to substrate loading position 120 to accept a substrate;
b. to fluid dispensing position 122 to dispense a sample fluid and optionally one or more calibrators, positive and negative controls, diluents, detergents, denaturing agents, blocking
c. agents, and/or other agents known to one of ordinary skill for immunodetection and SERS
d. analysis reagent via fluid handling system 104; and
e. to detection position 128 for SERS analysis, wherein heat source 124 heats the substrate as body 102 rotates from substrate loading position 120 to detection position 128.

Substrates of the present disclosure comprise at least one SERS reporter molecule, such as 2-aminothiophenol (ATP) or 4-Mercaptobenzoic acid (MBA). For example, solid substrates can be partially or entirely coated with at least one SERS reporter molecule while liquid substrates (e.g., a liquid nanoparticle suspension) have at least one SERS reporter molecule dispersed therein. Exemplary embodiments of substrates are described in U.S. Provisional Application No. 63/132,246, entitled “Surface Enhanced Raman Spectroscopy Methods for Detecting Analytes”, which is incorporated by reference herein in its entirety.

In some aspects, the SERS reporter molecules can be bound or conjugated to one or more analyte capture agents, such as, but not limited to, an antibody or antibody fragment thereof. As used herein, “antibody” includes both intact antibody molecules of the appropriate specificity and antibody fragments (including Fab, F(ab′), F(ab′)2, and Fv fragments), as well as chemically modified intact molecules and antibody fragments, including hybrid molecules assembled by in vitro re-association of subunits. Also included are genetically engineered antibodies of tile appropriate specificity and/or affinity, including single-chain derivatives. Both polyclonal and monoclonal antibodies are included unless otherwise specified. Specific examples of antibodies contemplated herein antibodies having an affinity for a target analyte, such as prostate specific antigen (PSA), creatine kinase MB (CKMB) isoenzyme, cardiac troponin I (cTnl) protein, thyroid-stimulating hormone (TSH), influenza A (Flu A) antigen, influenza B (Flu 8) antigen, and respiratory syncytial virus (RSV) antigen. Antibodies for such target analytes are known in the art.

When a sample fluid is added to the substrate, the analyte of interest binds the analyte capture agent forming an analyte-analyte capture agent-SERS reporter molecule complex. It will be understood that a substrate can comprise multiple analyte capture agents. For example, the substrate can comprise a first SERS reporter molecule bound to a first analyte capture agent and a second SERS reporter molecule bound to a second analyte capture agent, the first and second analyte capture agents being different. In some aspects, the first and second SERS reporter molecules can also be different.

In some aspects, the systems and methods disclosed herein can be used to detect an antibody of interest (i.e., a target antibody). In this aspect, the SERS reporter molecule is bound or conjugated to one or more antigens (i.e., antibody capture agent) that bind an antibody of interest. As used herein, “antigen” refers to a molecule structure, such as a toxin or foreign substance that binds an antigen-specific antibody or B-cell antigen receptor. In some aspects, a substrate can comprise multiple antigens. For example, the substrate can comprise a first SERS reporter molecule bound to a first antigen and a second SERS reporter molecule bound to a second antigen, the first and second antigens for binding different antibodies. In some aspects, the first and second SERS reporter molecules can also be different. For example, the first SERS reporter molecule can be ATP and the second SERS reporter molecule can be MBA

In some aspects, a single substrate can be used to simultaneously detect an antibody of interest and an analyte (i.e., non-antibody target) of interest. For example, the substrate can comprise a first SERS reporter molecule bound to an antibody to capture an analyte of interest and a second SERS reporter molecule bound to an antigen to capture an antibody of interest. The first and second SERS reporter molecules can be the same or different.

In some aspects, a calibrator can also be deposited onto a solid substrate for calibration of automated SERS system 100, and more specifically, detector 106. As used herein, “calibration” refers to a process for determining the relationship between an instrument response (measured response) and known analyte concentrations to ensure valid quantitation of a sample. In some aspects, the calibrator can comprise a single analyte. In some aspects, the calibrator can comprise multiple, different analytes. Positive and negative controls can also be deposited onto the substrate. In some aspects, calibrator(s) and/or control(s) can be dispensed onto a substrate by fluid handling system 104 when the substrate is in first fluid dispensing position 122 or second fluid dispensing position 124.

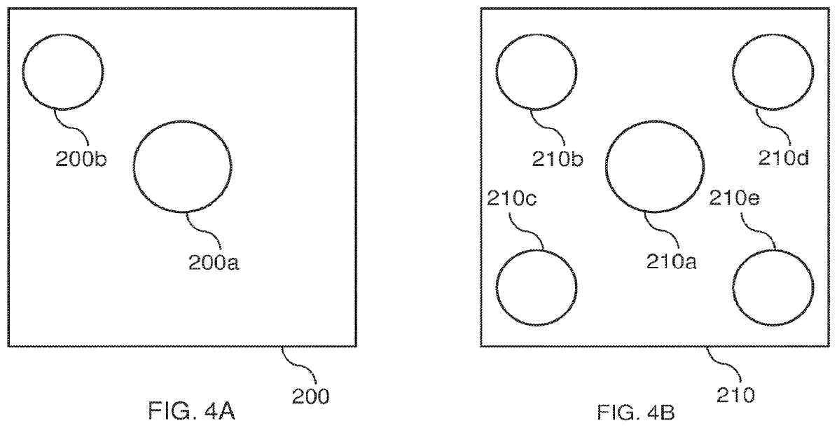

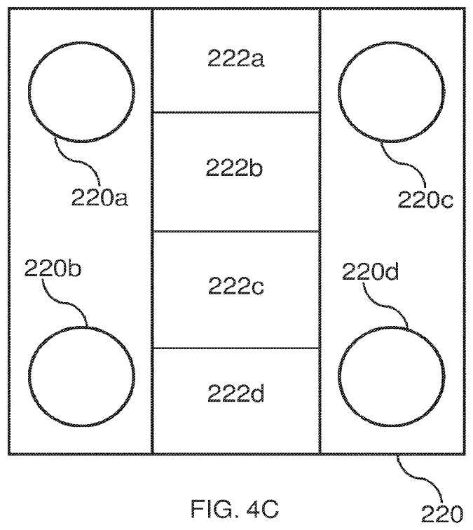

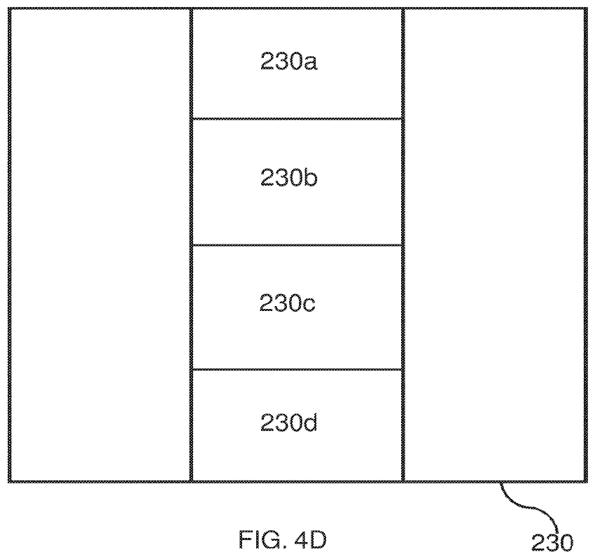

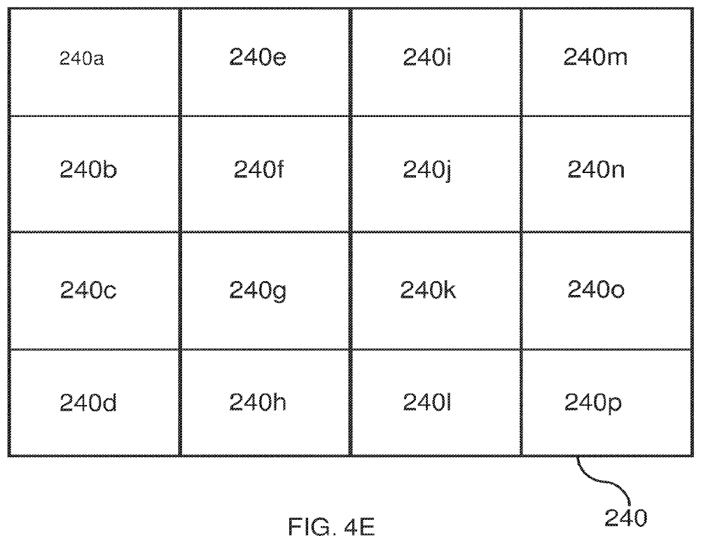

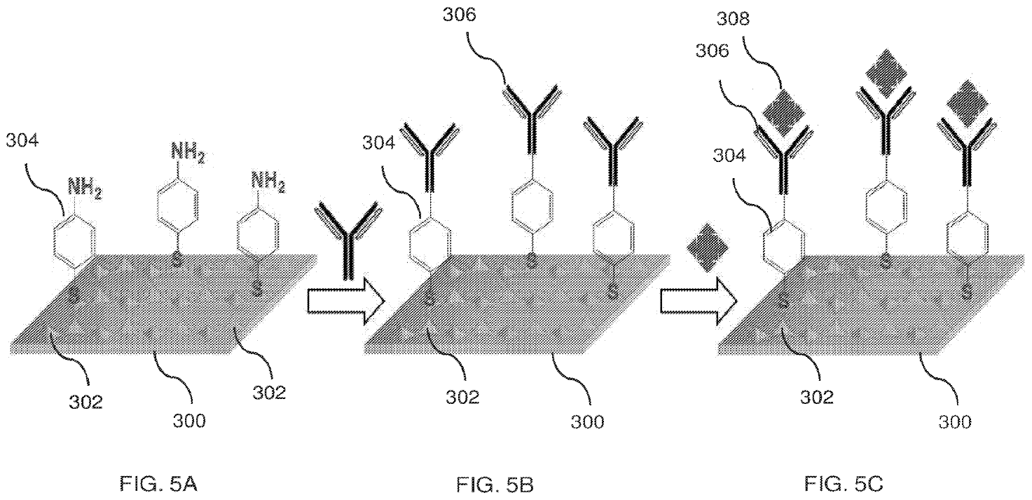

FIG. 4A illustrates a substrate according to some aspects of the disclosure. Substrate 200 includes sample fluid position 200a and calibrator position 200b. It will be understood that substrate 200 can include at least one calibrator position, alternatively at least two calibrator positions, alternatively at least three calibrator positions, alternatively at least four calibrator positions.

FIG. 4B illustrates another substrate 210 having sample fluid position 210a and calibrator positions 210b, 210c, 210d, and 210e. In some aspects, calibrator positions 210d and 210e can be substituted with a positive or negative control. For example, positions 210b and 210c can be calibrators, position 210d can be a positive control, and position 210e can be a negative control.

FIG. 4C illustrates another substrate according to some aspects of the disclosure. Substrate 220 can include calibrator positions 220a and 220b. In some aspects, substrate 220 can comprise optional positive and negative control positions 220c and 220d. Centrally located on substrate 220 are positions 222a, 222b, 222c, and 222d for receiving a sample fluid. In some aspects, positions 222a, 222b, 222c, and 222d are coated with the same analyte capture agent-SERS reporter molecule complex for analyte detection. In some aspects, positions 222a, 222b, 222c, and 222d are coated with the same SERS reporter molecule, each bound or conjugated to a unique analyte capture agent. In some aspects, positions 222a, 222b, 222c, and 222d are coated with the same SERS reporter molecule for direct binding of an analyte. In some aspects, positions 222a, 222b, 222c, and 222d are coated with different reporter molecules for direct binding of analytes.

FIG. 4D illustrates yet another substrate according to some aspects of the disclosure. Substrate 230 can include positions 230a, 230b, 230c, and 230d. Position 230a can receive a calibrator, position 230b can be for a positive control, position 230c can be for a negative control, and position 230d can receive a sample fluid.

FIG. 4E illustrates a further substrate according to some aspects of the disclosure. Substrate 240 can include positions 240a, 240b, 240c, 240d, 240e, 240f, 240g, 240h, 240i, 240j, 240k, 2401, 240m, 240n, 2400, 240p. At least one of positions 240a-240p can receive a calibrator with the remaining 15 positions for receiving a sample fluid.

It will be understood that the sample fluid position(s) of the substrates shown in FIGS. 4A-4E can be coated with one or more SERS reporter molecules bound or conjugated to one or more analyte capture agents (e.g., a capture antibody or a capture antigen).

In some aspects, rather than calibrator(s) being deposited on a substrate via automated SERS system 100, one or more calibrators are disposed on a substrate prior to loading onto body 102.

In some aspects, such as when the substrate is a liquid substrate (e.g., a liquid nanoparticle suspension), a liquid calibrator is dispensed by fluid handling system 104 and mixed with the liquid substrate, and control system 110 is configured to calibrate automated SERS system 100 prior to sample fluid testing.

In some aspects, substrates having configurations as shown in FIGS. 4A-4E are scanned by light source 108 from top to bottom and left to right for SERS analysis.

In some aspects, the substrate is a substantially planar chip, cartridge, or cassette on which one or more sample fluids can be deposited.

In some aspects, the substrate is a microstructure chip, a nanostructure chip, or a microfluidic chip. In exemplary aspects, a nanostructure chip comprises metal (e.g., gold or silver) nanoparticles disposed on the surface of a substantially planar substrate. The nanoparticles are coated with one or more SERS reporter molecules that are bound or conjugated to one or more analyte capture agents. FIGS. 5A-5C illustrates substrate 300 with a plurality of gold nanoparticles 302 disposed on its surface. As shown in FIG. SA, nanoparticles 302 are coated with SERS reporter molecule 304 (ATP depicted as a non-limiting example). In FIG. SB, substrate 300 is incubated with analyte capture agent 306, which binds SERS reporter molecule 304. The substrate shown in FIG. SB can be loaded onto an automated SERS system as disclosed herein at substrate loading position 120. Upon rotation of body 102 to sample fluid dispensing position 122, fluid handling system 104 dispenses a sample fluid having an analyte of interest onto substrate 300. Analyte 308 then binds analyte capture agent 306 (FIG. SC), and the analyte-capture agent-reporter molecule complex undergoes optional further processing before SERS detection and analysis.

In another aspect, nanoparticles coated with a SERS reporter molecule conjugated to an analyte capture agent are prepared in a liquid suspension. The liquid nanoparticle suspension can be mixed with a sample fluid via fluid handling system 104 to bind an analyte of interest.

Automated SERS system 100 can also analyze substrates in which a sample fluid is deposited onto the substrate prior to the substrate being loaded onto body 102. In this aspect, control system 110 is configured to identify a “pre-filled” substrate (i.e., a substrate previously filled with a sample fluid) and sequentially rotates body 102 as follows:
a. to substrate loading position 120 to accept the pre-filled substrate; and
b. to detection position 128 for SERS analysis, wherein the substrate can be heated by heat source 124 as body 102 rotates.

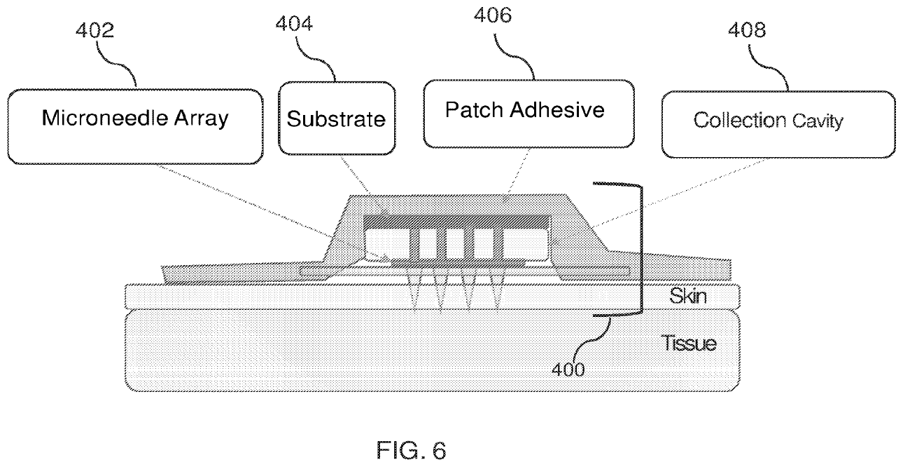

In some aspects, the substrate is removably coupled to a microneedle patch that includes a microneedle array, a patch adhesive, the substrate, and a collection cavity. The patch adhesive can be a bandage or topical dressing worn by a subject or patient. The microneedle patch uses capillary action to draw a biological fluid from the subject into the substrate. FIG. 6 illustrates a microneedle patch assembly according to some aspects of the disclosure. Microneedle patch assembly 400 includes microneedle array 402, substrate 404, patch adhesive 406, and collection cavity 408. After sample collection, an operator or technician removes substrate 404 from assembly 400 and loads the substrate onto the automated SERS system as disclosed herein.

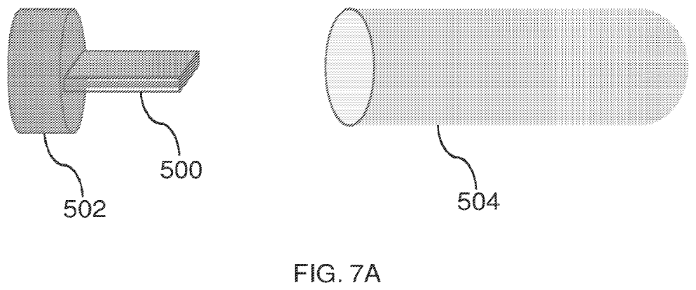

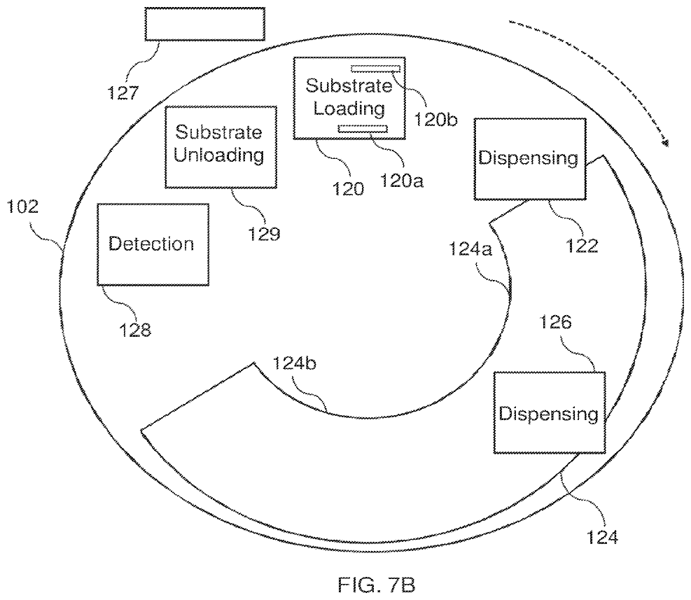

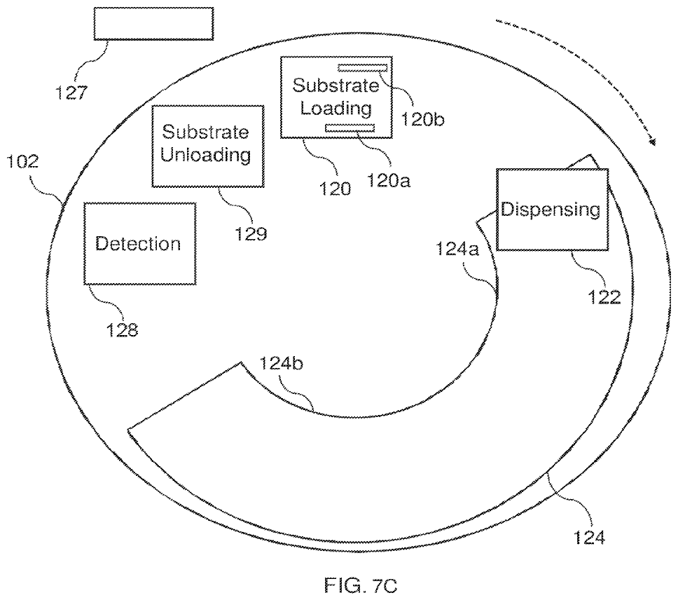

FIG. 7A illustrates another substrate suitable for pre-filling with a sample fluid. Substrate 500 extends from and is removably coupled to cap 502. Cap 502 mates with or removably couples to container 504. Container 504 can be a test tube, vial, cuvette, or other suitable structure for collecting a sample fluid. When substrate 500 is inserted into container 504, the sample fluid is drawn into the substrate via capillary action. In some aspects, after sample collection, an operator or technician can uncouple cap 502 from container 504 to expose substrate 500. Substrate 500 can then be detached from cap 502 and loaded onto the automated SERS system as disclosed herein.

Alternatively, in some aspects, when the pre-filled substrate comprises the assembly shown in FIG. 7A, the method can further comprise removing cap 502 from container 504 to expose substrate 500. In this aspect, as shown in FIGS. 7B and 7C, automated SERS system 100 can include substrate handler 127 that is configured to remove cap 502 from container 504 (exposing substrate 500) and load the cap onto body 102.

In a further aspect, the disclosure provides methods of automated SERS analysis using a system as described herein.

In some aspects, a method of continuously accepting and analyzing sample fluids by SERS comprises:
a. providing an automated SERS system of the disclosure with one or more sample fluids;
b. loading one or more substrates of the disclosure onto the body of the automated SERS system when the body is at the substrate loading position via a substrate transport device;
c. dispensing a sample fluid having an analyte of interest from a fluid handling system onto the substrate when the body is at the sample fluid dispensing position;
d. scheduling a control system to rotate the body between a plurality of positions of the automated SERS system;
e. exciting a SERS reporter molecule of the substrate with a light source;
f. collecting and detecting Raman scattered light from the analyte of interest bound to the SERS reporter molecule of the substrate to produce a set of corresponding values; and
g. determining the presence and/or concentration of the analyte in the sample fluid using the corresponding values.

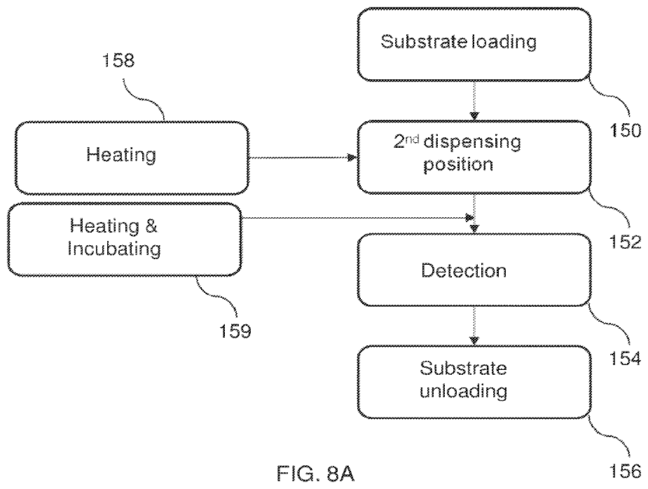

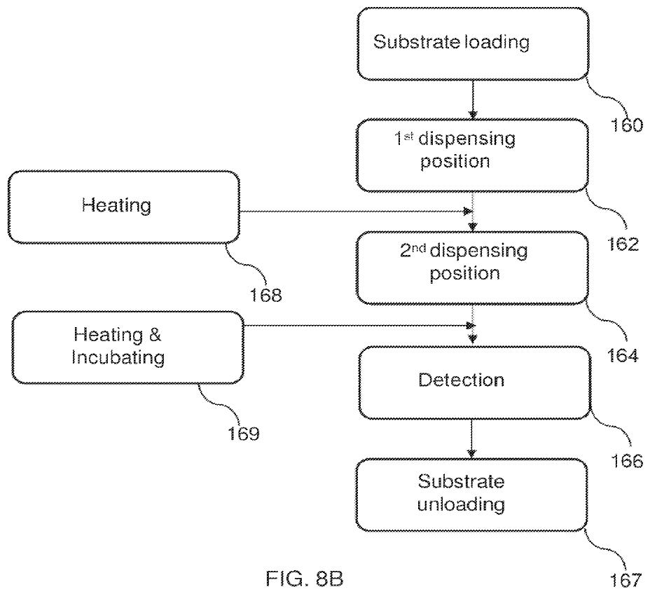

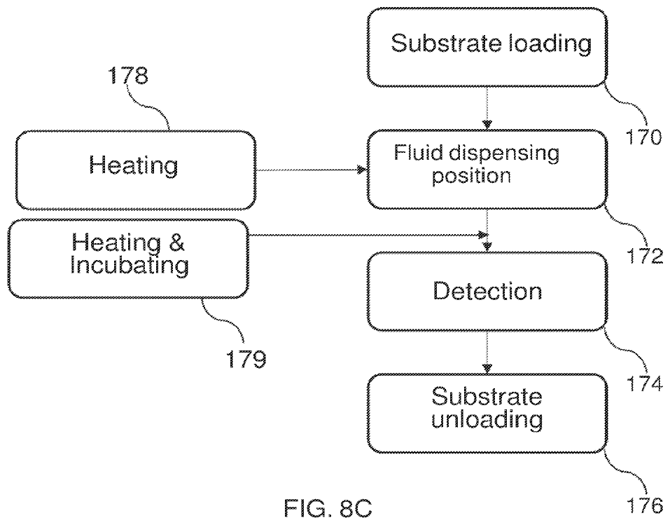

FIGS. 8A-8C are flow chart diagrams showing automated methods for SERS using the system disclosed herein. In some aspects, the method comprises:
a. rotating body 102 to substrate loading position 120 to accept a substrate (150 in FIG. 8A);
b. rotating body 102 from substrate loading position 120 to second fluid dispensing position 126 to dispense a sample fluid via fluid handling system 104 (152 in FIG. 8A), wherein as body 102 rotates, heat source 124a heats the substrate (158 in FIG. 8A);
c. rotating body 102 from second fluid dispensing position 156 to detection position 128 for SERS analysis (154 in FIG. 8A), wherein as body 102 rotates, heat source 124b heats the substrate (159 in FIG. 8A). Further, during this rotation, the analyte of interest in the sample fluid is incubated with the analyte capture agent to facilitate binding of the analyte of interest and the analyte capture agent (159 in FIG. 8A); and
d. rotating body 102 from detection position 128 to substrate unloading position 129 to discard the used substrate (156 in FIG. 8A).

In some aspects, the method comprises:
a. rotating body 102 to substrate loading position 120 to accept a substrate (150 in FIG. 8A);
b. rotating body 102 from substrate loading position 120 to second fluid dispensing position 126 to dispense a sample fluid via fluid handling system 104 (152 in FIG. 8A), wherein as body 102 rotates, heat source 124a heats the substrate (158 in FIG. 8A);
c. optionally dispensing one or more reagents via fluid handling system 104 at second fluid dispensing position 126 such as calibrators, positive and negative controls, diluents, detergents, denaturing agents, blocking agents, and/or other agents known to one of ordinary skill for immunodetection and SERS analysis reagent via fluid handling system 104;
d. rotating body 102 from second fluid dispensing position 126 to detection position 128 for SERS analysis (154 in FIG. 8A), wherein as body 102 rotates, heat source 124b heats the substrate (159 in FIG. 8A). Further, during this rotation, the analyte of interest in the sample fluid is incubated with the analyte capture agent to facilitate binding of the analyte of interest and the analyte capture agent (159 in FIG. 8A); and
e. rotating body 102 from detection position 128 to substrate unloading position 129 to discard the used substrate (156 in FIG. 8A).

In some aspects, the method comprises:
a. rotating body 102 to substrate loading position 120 to accept a substrate (160 in FIG. 8B);
b. rotating body 102 from substrate loading position 120 to first fluid dispensing position 122 to dispense a sample fluid and optionally one or more reagents such as a denaturing agent onto a pre-treatment portion of the substrate (i.e., a portion of the substrate lacking a SERS reporter molecule bound to an analyte capture agent) via fluid handling system 104 (162 in FIG. 8B) resulting in a pre-treatment sample fluid;
c. rotating body 102 from first fluid dispensing position 122 to second fluid dispensing position 126 (164 in FIG. 8B), wherein as body 102 rotates, heat source 124a heats the substrate (168 in FIG. 8B);
d. at second fluid dispensing position 126, aspirating the pre-treatment sample fluid (e.g., denatured sample fluid) via fluid handling system 104 and dispensing the pre-treatment sample fluid onto a portion of the substrate coated with the SERS reporter molecule bound to the analyte capture agent;
e. rotating body 102 from second fluid dispensing position 126 to detection position 128 for SERS analysis (166 in FIG. 8B), wherein as body 102 rotates, heat source 124b heats the substrate (169 in FIG. 8B). Further, during this rotation, the analyte of interest in the sample fluid is incubated with the analyte capture agent to facilitate binding of the analyte of interest and the analyte capture agent (169 in FIG. 8B); and
f. rotating body 102 from detection position 128 to substrate unloading position 129 to discard the used substrate (167 in FIG. 8B).

In some aspects, the method comprises:
a. rotating body 102 to substrate loading position 120 to accept a substrate (160 in FIG. 8B);
b. rotating body 102 from substrate loading position 120 to first fluid dispensing position 122 to dispense a sample fluid and optionally one or more reagents such as a denaturing agent onto a pre-treatment portion of the substrate (i.e., a portion of the substrate lacking a SERS reporter molecule bound to an analyte capture agent) via fluid handling system 104 (162 in FIG. 8B) resulting in a pre-treatment sample fluid;
c. optionally dispensing one or more additional reagents via fluid handling system 104 at first fluid dispensing position 122 such as calibrators, positive and negative controls, diluents, detergents, blocking agents, and/or other agents known to one of ordinary skill for immunodetection and SERS analysis;
d. rotating body 102 from first fluid dispensing position 122 to second fluid dispensing position 126 (164 in FIG. 8B), wherein as body 102 rotates, heat source 124a heats the substrate (168 in FIG. 8B);
e. at second fluid dispensing position 126, aspirating the pre-treatment sample fluid (e.g., denatured sample fluid) via fluid handling system 104 and dispensing the pre-treatment sample fluid onto a portion of the substrate coated with the SERS reporter molecule bound to the analyte capture agent;
f. optionally dispensing one or more calibrators, positive and negative controls, diluents, detergents, denaturing agents, blocking agents, and/or other agents known to one of ordinary skill for immunodetection and SERS analysis reagent via fluid handling system 104 when body 102 is at second fluid dispensing position 126;
g. rotating body 102 from second fluid dispensing position 126 to detection position 128 for SERS analysis (166 in FIG. 8B), wherein as body 102 rotates, heat source 124b heats the substrate (169 in FIG. 8B). Further, during this rotation, the analyte of interest in the sample fluid is incubated with the analyte capture agent to facilitate binding of the analyte of interest and the analyte capture agent (169 in FIG. 8B); and
h. rotating body 102 from detection position 128 to substrate unloading position 129 to discard the used substrate (167 in FIG. 8B).

In some aspects, when body 102 comprises a singular fluid dispensing position, the method comprises:
a. rotating body 102 to substrate loading position 120 to accept a substrate (170 in FIG. 8C);
b. rotating body 102 from substrate loading position 120 to fluid dispensing position 122 to dispense a sample fluid (172 in FIG. 8C), wherein as body 102 rotates, heat source 124a heats the substrate (178 in FIG. 8C);
c. rotating body 102 from fluid dispensing position 122 to detection position 128 for SERS analysis (174 in FIG. 8C), wherein as body 102 rotates, heat source 124b heats the substrate (179 in FIG. 8C). Further, during this rotation, the analyte of interest in the sample fluid is incubated with the analyte capture agent to facilitate binding of the analyte of interest and the analyte capture agent (179 in FIG. 8C); and
d. rotating body 102 from detection position 128 to substrate unloading position 129 to discard the used substrate (179 in FIG. 8C).

In some aspects, when body 102 comprises a singular fluid dispensing position, the method comprises:
a. rotating body 102 to substrate loading position 120 to accept a substrate (170 in FIG. 8C);
b. rotating body 102 from substrate loading position 120 to fluid dispensing position 122 to dispense a sample fluid (172 in FIG. 8C), wherein as body 102 rotates, heat source 124a heats the substrate (178 in FIG. 8C);
c. optionally dispensing one or more additional reagents via fluid handling system 104 fluid dispensing position 122 such as calibrators, positive and negative controls, diluents, detergents, blocking agents, denaturing agents and/or other agents known to one of ordinary skill for immunodetection and SERS analysis; and
d. rotating body 102 from fluid dispensing position 122 to detection position 128 for SERS analysis (174 in FIG. 8C), wherein as body 102 rotates, heat source 124b heats the substrate (179 in FIG. 8C). Further, during this rotation, the analyte of interest in the sample fluid is incubated with the analyte capture agent to facilitate binding of the analyte of interest and the analyte capture agent (179 in FIG. 8C); and
e. rotating body 102 from detection position 128 to substrate unloading position 129 to discard the used substrate (179 in FIG. 8C).

In some aspects of the method, the duration of incubation for analyte-analyte capture agent complexing is 10 minutes-30 minutes, alternatively 10 minutes-25 minutes, alternatively 10 minutes-20 minutes, alternatively 10 minutes-15 minutes.

In some aspects of the method, the duration of excitation and detection at detection position 128 is 10 seconds-10 minutes.

In some aspects of the method, an automated SERS system rotates at 10 minutes/revolution-60 minutes/revolution, alternatively 10 minutes/revolution-50 minutes/revolution, alternatively 10 minutes/revolution-40 minutes/revolution, alternatively 10 minutes/revolution-30 minutes/revolution, alternatively 10 minutes/revolution-20 minutes/revolution, depending on the number of substrate-accepting positions in body 102.

In the systems and methods disclosed herein, determining one analyte constitutes a test performed by the automated SERS system. In some aspects, the method comprises performing about at least ten tests per hour. In some aspects, the method comprises performing about at least 100 tests per hour. In some aspects, the method comprises performing about at least 400 tests per hour.

In some aspects, the method further comprises calibrating the automated system using a calibrator as detailed herein.

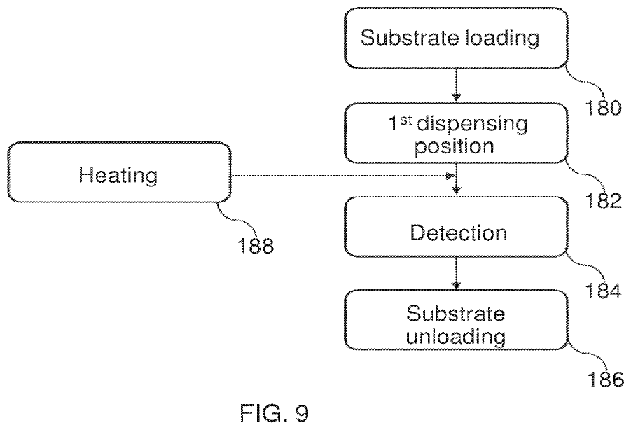

In some aspects of the method, a sample fluid is deposited onto the substrate prior to the substrate being loaded onto body 102. In this aspect, the method can comprise identifying a “pre-filled” substrate (i.e., a substrate previously filled with a sample fluid), and further comprises:
a. rotating body 102 to substrate loading position 120 to accept a pre-filled substrate (180 in FIG. 9);
b. optionally rotating body 102 from substrate loading position 120 to first fluid dispensing position 122 to dispense one or more calibrators, positive and negative controls, diluents, detergents, blocking agents, denaturing agents and/or other agents known to one of ordinary skill for immunodetection and SERS analysis (182 in FIG. 9);
c. rotating body 102 from first fluid dispensing position 122 to detection position 128 for SERS analysis (184 in FIG. 9), wherein as body 102 rotates, heat source 124 heats the substrate (188 in FIG. 9).

Additional examples are provided below.

### EXAMPLES

### Example 1: Substrate Fabrication

Gold nanoparticles affixed to a substantially planar substrate were coated with the SERS reporter molecule 4-aminothiophenol (ATP) as shown in FIG. SA A monoclonal thyroid-stimulating hormone (TSH) antibody was bound to the ATP to capture TSH analytes in a sample fluid. Experimental conditions, including reagents, solvents, and processing parameters, for generating nanoparticles on an underlayer. The underlayer (quartz slides) was treated by immersion into an acid/peroxide solution (H2S04:H202=3:1) under heating at 90° C. for 2 hours. The underlayer was then cleaned by ultrasonication for 10 minutes in acetone, ethanol, and DI water successively. Polystyrene beads were subsequently dip-coated onto the underlayer. Chromium and gold were deposited using e-beam evaporation. The deposition rates were 0.05 nm/sand 0.25 nm/s for chromium and gold deposition, respectively. The polystyrene beads were removed by ultrasonication for 10 minutes in ethanol. Gold nanoparticle arrays were obtained on the underlayer upon removal of the beads.

10 μL of 20 μg/ml TSH monoclonal antibody (mAb) (Thermo Fisher) in phosphate-buffered saline (PBS) was first mixed with 50 μL of PBS solution containing 50 mM sulfo-N-hydroxy succinimide (Sigma-Aldrich) and 200 mM 1-Ethyl-3-(3-dimethylaminopropyl) carbodiimide (EDC) for 5 min. The 150 μL mixture was then dropped to cover the entire substrate and incubated for 12 hours at room temperature. The substrate was then washed using ACCESS™ wash buffer II (Beckman Coulter; 19.6 mM Tris, 150 mMNaCl, 0.1% NaN3, 0.1% ProClin 300, pH 8.31±0.05 at 25° C.) to remove excess reagents and dried using compressed air.

The substrate was blocked in 10 mg/mL BSA in PBS for 12 hours. The substrate was then washed using ACCESS™ wash buffer II to remove excess reagents and dried using compressed air.

### Example 2: Schedule of an Automated SERS System for TSH Detection

The substrate was subsequently provided to an automated SERS system comprising body 602 as shown in FIG. 10 to measure the level of TSH in a sample fluid. The TSH sample was prepared in 20 mM phosphate buffer with 10% BSA, 0.5% Tween-20, and 0.05% of sodium azide. Body 602 comprises substrate loading position 620, first fluid dispensing position 622, second fluid dispensing position 624, detection position 628, and substrate unloading position 629. Body 602 further comprises heat source 624a disposed between first fluid dispensing position 622 and second fluid dispensing position 624 and heat source 624b disposed between second fluid dispensing position 624 and detection position 628. Circles 0-11 depicted in FIG. 10 correspond to functional steps for SERS analysis, and where these steps occur relative to the rotational axis of body 602. Table 1 shows the schedule of the control system for TSH detection for automated SERS analysis using the system described herein. The sample was excited with a laser at 785 nm, and Raman peak shifts captured by a detector.

TABLE 1
Schedule for TSH analysis

| | | Position | Start | |
|---|---|---|---|---|
| Action | Function | (FIG. to) | Time | Duration |
| Load substrate | Add substrate to body | 0 | 0:00:00 | 0:00:30 |
| Pre-heat | Warm substrate to 40° C. | 1-4 | 0:02:30 | 0:07:30 |
| substrate | | | | |
| Sample addition | Dispense 50 uL sample | 4 | 0:10:00 | 0:00:15 |
| | fluid | | | |
| Incubation | React TSH in sample fluid | 4-10 | 0:10:00 | 0:15:00 |
| | with TSH antibody of | | | |
| | substrate at 37° C. | | | |
| Detection | Excite laser and measure | 10 | 0:25:00 | 0:01:00 |
| | Raman profile | | | |
| Unload substrate | Remove substrate from | 11 | 0:27:30 | 0:00:30 |
| | body | | | |

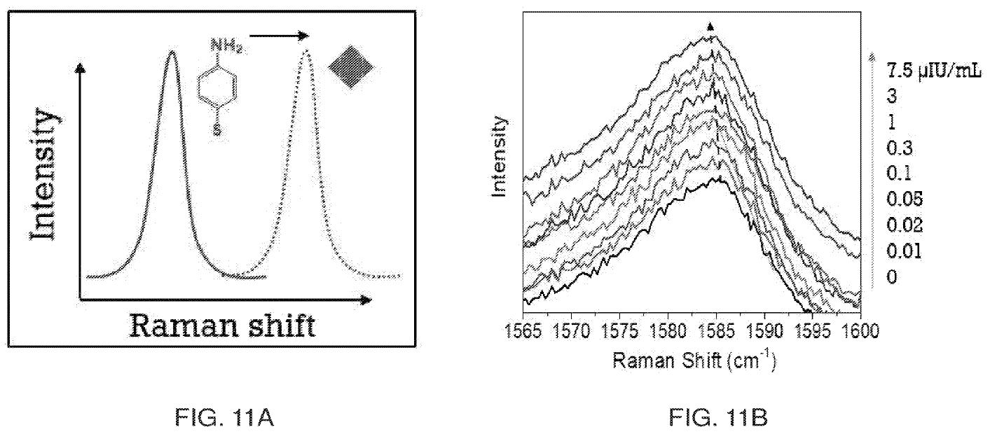

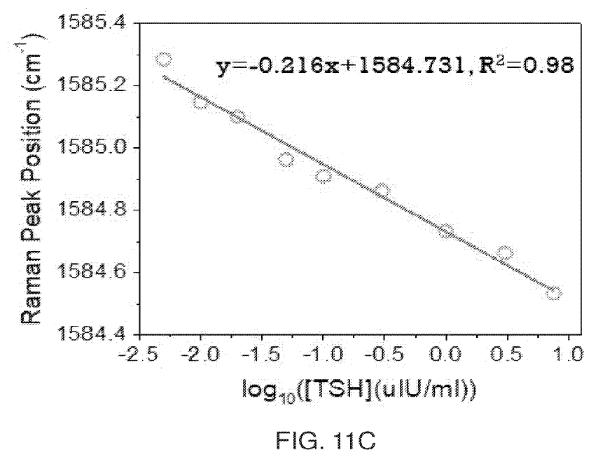

Results of Example 2 are shown in FIGS. 11A-11C represent functional steps for SERS analysis. FIG. 11A depicts a plot of signal intensity as a function of Raman peak shift when the SERS reporter molecule-analyte capture agent complex (i.e., ATP conjugated to TSH mAb) binds TSH in the sample fluid. The complex exhibits a shift of a Raman peak or feature (e.g., a shoulder on a peak) in a higher wavenumber direction when the TSH antibody of the complex binds the target TSH analyte. FIG. 11B shows resulting spectra data between 1565 cm·¹ and 1600 cm·¹ at concentrations ranging from 0 μLU/ml TSH to 7.5 μLU/ml TSH. The SERS reporter molecule-analyte capture agent complex exhibited a shift of a Raman peak or feature in a lower frequency direction when bound to TSH in the sample fluid. The dashed arrow in FIG. 11B is angled toward the left (i.e., toward a lower frequency direction), indicating that at the highest TSH concentration (top most spectrum), the peak/feature at approximately 1585 cm·¹ shifted to the left relative to the spectrum obtained in the absence of TSH (i.e., 0 μLU/ml TSH, bottom most spectrum). FIG. 11C is a plot of the Raman peak position in cm·¹ as a function of log10 of the TSH concentration corresponding to the Raman shift data of FIG. 11B.

### Example 3: Schedule of an Automated SERS System for Vitamin B12 Detection

Table 2 shows an exemplary schedule of a control system for B12 detection using body 602 of an automated SERS system as disclosed herein and a SERS reporter molecule conjugated to an anti-B12 antibody to bind vitamin B12 in a sample fluid.

TABLE 2
Schedule of an automated SERS system for vitamin B12 detection

| | | Position | Start | |
|---|---|---|---|---|
| Action | Function | (FIG. to) | Time | Duration |
| Load substrate | Add substrate to body | 0 | 0:00:00 | 0:00:30 |
| Pre-heat | Warm substrate to 40° C. | 1-4 | 0:02:30 | 0:07:30 |
| substrate | | | | |
| Pre-treatment | Dispense 50 uL of pre- | 1 | 0:03:00 | 0:00:15 |
| | treatment reagent (i.e., | | | |
| | denaturing agent) onto pre- | | | |
| | treatment position of | | | |
| | substrate | | | |
| Sample addition | Dispense 50 uL sample | 1 | 0:03:15 | 0:00:15 |
| | fluid onto pre-treatment | | | |
| | position of | | | |
| | substrate | | | |
| Aspirate sample | Aspirate 50 uL of | 4 | 0:10:00 | 0:00:15 |
| | denatured sample | | | |
| Sample addition | Dispense 50 uL of | 4 | O:10:15 | 0:00:15 |
| | denatured sample onto | | | |
| | position of substrate | | | |
| | having SERS reporter | | | |
| | molecule-analyte | | | |
| | capture agent complex | | | |
| Incubation | React vit B12 in sample | 4-10 | 0:10:00 | 0:15:00 |
| | fluid with vit B12 antibody | | | |
| | of substrate at 37° C. | | | |
| Detection | Excite laser and measure | 10 | 0:25:00 | 0:01:00 |
| | Raman profile | | | |
| Unload substrate | Remove substrate from | 11 | 0:27:30 | 0:00:30 |
| | body | | | |

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1.-124. (canceled)

125. An automated system configured to continuously accept and analyze a plurality of sample fluids, the automated system comprising:
a body, wherein the body has a rotational axis and at least one opening for receiving a substrate, wherein the substrate comprises at least one Surface Enhanced Raman Spectroscopy (SERS) reporter molecule;
a plurality of positions, wherein the plurality of positions comprises:
at least one substrate loading position;
at least one fluid dispensing position disposed after the at least one substrate loading position; and
at least one detection position disposed after the at least one fluid dispensing position;
at least one heat source extending between the at least one substrate loading position and the at least one detection position;
a control system;
wherein the substrate is loaded onto the body when the body is at the at least one substrate loading position via a substrate transport device and the body is configured to move the substrate between the plurality of positions according to a schedule of the control system;
a fluid handling system configured to dispense a sample fluid comprising at least one analyte of interest;
at least one light source configured to excite the SERS reporter molecule;
a detector configured to collect and detect Raman scattered light from the at least one analyte of interest bound to the SERS reporter molecule and thereby produce a set of corresponding values when the substrate is at the at least one detection position; and
wherein the automated system is further configured to determine a presence and/or concentration of the at least one analyte of interest in the sample fluid using the corresponding values.

126. The automated system of claim 125, wherein the control system is scheduled to rotate the body sequentially from the at least one substrate loading position to the at least one fluid dispensing position to the at least one detection position.

127. The automated system of claim 126, wherein as the control system rotates the body from the at least one substrate loading position to the at least one fluid dispensing position, a first portion of the at least one heat source heats the substrate resulting in a pre-heated substrate.

128. The automated system of claim 127, wherein the fluid handling system dispenses the sample fluid onto the pre-heated substrate when the body is at the at least one fluid dispensing position.

129. The automated system of claim 128, wherein as the control system rotates the body from the at least one fluid dispensing position to the at least one detection position, a second portion of the at least one heat source heats the substrate resulting in a pre-heated substrate.

130. The automated system of claim 125, wherein the SERS reporter molecule is bound to an analyte capture agent that binds the analyte of interest.

131. The automated system of claim 125, wherein the fluid handling system dispenses one or more reagents and the sample fluid onto a pre-treatment portion of the substrate when the body is at the at least one fluid dispensing position to prepare a pre-treated sample fluid, wherein the pre-treatment portion of the substrate lacks the SERS reporter molecule.

132. The automated system of claim 125, wherein the plurality of positions further comprises a substrate unloading position.

133. The automated system of claim 125, wherein the fluid handling system comprises a container handler and/or a pipettor arrangement.

134. The automated system of claim 125, wherein determining one analyte constitutes a test performed by the automated system, and the automated system is configured to perform about at least 10 tests per hour.

135. The automated system of claim 125, wherein determining one analyte constitutes a test performed by the automated system, and the automated system is configured to perform about at least 100 tests per hour.

136. The automated system of claim 125, wherein determining one analyte constitutes a test performed by the automated system, and the automated system is configured to perform about at least 400 tests per hour.

137. The automated system of claim 125, wherein the substrate comprises a first SERS reporter molecule bound to a first analyte capture agent and a second SERS reporter molecule bound to a second analyte capture agent.

138. The automated system of claim 125, wherein the substrate is a solid substrate.

139. The automated system of claim 138, wherein the substrate is substantially planar.

140. The automated system of claim 138, wherein the substrate comprises at least one position for receiving the sample fluid and at least one position for receiving a calibrator.

141. The automated system of claim 140, wherein the substrate comprises at least two positions for a calibrator, alternatively at least three positions for a calibrator, alternatively at least four positions for a calibrator.

142. The automated system of claim 138, wherein the substrate is a microstructure chip or a microfluidic chip.

143. The automated system of claim 138, wherein the substrate is removably coupled to a microneedle patch, the microneedle patch comprising a microneedle array, a patch adhesive, the substrate, and a collection cavity.

144. The automated system of claim 138, wherein the substrate extends from and is removably coupled to a container cap, the container cap being removably coupled to a container, wherein the container contains the sample fluid, and the sample fluid is drawn into the substrate via capillary action.
